(19) United States
(12) Patent Application Publication
(10) Pub. No.: US 2017/0147753 A1
(43) Pub. Date: May 25, 2017

(54) METHOD FOR SEARCHING FOR SIMILAR CASE OF MULTI-DIMENSIONAL HEALTH DATA AND APPARATUS FOR THE SAME

(71) Applicant: Electronics and Telecommunications Research Institute, Daejeon (KR)

(72) Inventors: Youngwoong HAN, Daejeon (KR); Ho-Youl JUNG, Daejeon (KR); Jae Hun CHOI, Daejeon (KR); Minho KIM, Daejeon (KR); YoungWon KIM, Daejeon (KR); Myung-eun LIM, Daejeon (KR); Dae Hee KIM, Daejeon (KR); Seunghwan KIM, Daejeon (KR)

(21) Appl. No.: 15/349,703

(22) Filed: Nov. 11, 2016

(30) Foreign Application Priority Data
Nov. 25, 2015 (KR) 10-2015-0165491

(51) Int. Cl. G06F 19/00; G06N 99/00; G06F 17/30

(52) U.S. Cl. CPC G06F 19/322; G06F 19/3443; G06F 19/3437; G06F 17/30598; G06F 17/30867; G06N 99/005

(57) ABSTRACT

Provided are a search method and device in which, in order to search for health data having a multivariate (multi-dimensional) time-series characteristic with high calculation complexity for a search, a format of the health data is converted and a dimension of the health data is reduced through feature extraction to which a learning model is applied, so that the calculation complexity for the search may be remarkably reduced and the similar case search may be performed efficiently.

### CROSS-REFERENCE TO RELATED APPLICATIONS

This U.S. non-provisional patent application claims priority under 35 U.S.C. §119 of Korean Patent Application No. 10-2015-0165491, filed on Nov. 25, 2015, the entire contents of which are hereby incorporated by reference.

### BACKGROUND

The present disclosure herein relates to a method and device for searching for a similar case from multi-dimensional health data, and more particularly, to a search method and device in which, in order to search for health data having a multivariate (multi-dimensional) time-series characteristic with high calculation complexity for a search, a format of the health data is converted and a dimension of the health data is reduced through feature extraction to which a learning model is applied, so that the calculation complexity for the search is remarkably reduced, and a similarity calculation is performed only for the health data within a selected cluster without performing the similarity calculation for all data by clustering highly similar health data, thereby enabling an efficient search for a similar case.

Recently, as the standard of living of people increases with the development of industrial technology and increase of income, population ageing of society is becoming serious, and prevalence rates of various diseases such as chronic diseases are increasing due to a change of a lifestyle and bad eating habits.

Accordingly, people are more interested in health and wellbeing than ever, and various health promotion services are provided to users by hospitals, oriental medical clinics, or healthcare service providers by using public health data provided by domestic or foreign large medical institutions or government.

For example, a service such as “patient like me” provides a search service which collects health data of many persons to allow a user to search for health data (symptoms and prescriptions) of persons having the same disease as the user. Furthermore, various services based on health big data are provided, for example, reference materials for promoting health are provided on the basis of results of searches through the search service.

As described above, a health promotion service based on health big data may search for health data of persons having health condition similar to that of users, may predict future health condition of the users with reference to the progress of changes in health condition of the persons on the basis of retrieved health data, and may find a method for promoting health of the users on the basis of information (e.g., prescription methods or eating habits) of the health data. Therefore, it is very important for the users or health promotion service providers to correctly search for the health data of the persons having health condition similar to that of the users.

However, the health data is a record lacking a class (e.g., disease name) according to a result of a personal periodic medical examination or is time-series data in which eating/living habits or prescriptions according to personal health condition are recorded according to a time, and the personal health condition includes various numerical values (e.g., blood glucose or blood pressure). Therefore, the health data is multivariate (multi-dimensional) data.

To calculate similarity between health data having characteristics of multivariate time-series data, the numerical health values should be compared one by one for all health data. Therefore, calculation complexity is very high, and time complexity is also high since the data is large-size big data.

According to a typical service for searching for a similar case of health data, a search speed is slow or a large amount of search results is achieved due to the above-mentioned characteristics of health data.

Furthermore, according to the typical service for searching for a similar case of health data, a specific keyword is input, and according to a simple mechanical mechanism, the keyword is set as a priority for the health data, and health data is retrieved and provided according to the priority, but health data which is highly similar to health condition of a user cannot be properly retrieved, and good-quality health data or a similar case based on health data cannot be provided to the user.

That is, a simple search technology for big data exists, but there is no search technology reflecting multivariate time-series data such as health data.

Therefore, the present disclosure provides a similar case search method and device for multi-dimensional data. According to the method and device, the complexity of a calculation for measuring the similarity is remarkably reduced by reducing the dimension of health data having characteristics of multivariate time-series data by applying a machine-learning-based feature extraction technology to the health data, so that hospitals, oriental medical clinics, or various service providers may quickly search for similar cases based on personal health data of users to smoothly provide health promotion services suitable for health condition of the users, and the users may be provided with health data of persons having health condition similar to that of the users so that the users may find health promotion methods suitable for the users.

### SUMMARY

The present disclosure provides a device and method for searching for a similar case in near real time in order to provide a health promotion service to a user on the basis of personal health data of the user by remarkably reducing the complexity of a calculation of similarity by reducing the dimension of health data having a multivariate time-series characteristic by applying a technique for reducing the dimension of specific data, such as deep network learning or PCA, to the health data.

An embodiment of the inventive concept provides a method for searching for a similar case from multi-dimensional health data, the method including: preprocessing health data or personal health data of a user; and generating a corresponding learning model through learning on the health data.

In an embodiment, the method may further include: extracting features of the health data from the health data and the learning model; and performing clustering to perform grouping by each of the extracted features.

In an embodiment, the method may further include extracting converted query data by applying personal health data of a user to the generated learning model.

In an embodiment, the method may further include: selecting a corresponding cluster from clusters obtained by performing grouping by each of the features of the health data extracted from the health data and the generated learning model using the converted query data; and predicting similarity between the personal health data of the user and the health data corresponding to the selected cluster.

In an embodiment, the preprocessing may include: normalizing the health data, personal health data of a user, or a combination thereof; dividing the normalized health data and personal health data by a length of a time window by applying the time window; and vectorizing the divided health data and personal health data.

In an embodiment, the normalizing may include making the health data and the personal health data of the user follow a normal distribution through log transformation or square root transformation in a case where the health data and the personal health data of the user do not follow the normal distribution and rescaling z-score for the health data and the personal health data of the user which follow the normal distribution to a value of from 0 to 1.

In an embodiment, during the generating the corresponding learning model, the learning model for reducing a dimension of the preprocessed health data may be established, wherein a technique for reducing a health data dimension, such as deep network learning or principal component analysis (PCA), may be applied to the learning model. The technique for the learning model is not particularly limited in embodiments of the inventive concept.

In an embodiment, the performing the clustering may include storing the health data for a corresponding cluster by grouping by each of the extracted features for the learning model, wherein the grouping may be performed through lattice-based grouping or cube-type grouping.

In an embodiment of the inventive concept, a device for searching for a similar case from multi-dimensional health data includes: a preprocessing unit configured to preprocess health data or personal health data of a user; and a learning model configured to generate a corresponding learning model through learning on the health data.

In an embodiment, the device may further include: a feature extraction unit configured to extract features of the health data from the health data and the learning model; and a clustering unit configured to perform grouping by each of the extracted features.

In an embodiment, the device may further include a similarity prediction unit configured to select a corresponding cluster from clusters obtained by performing grouping by each of the features of the health data extracted from the health data and the generated learning model using query data converted by applying the personal health data of the user to the generated learning model, and predict similarity between the personal health data of the user and the health data corresponding to the selected cluster.

In an embodiment, the preprocessing unit may perform a process of normalizing the health data, the personal health data of the user, or a combination thereof, dividing the normalized health data and personal health data by a length of a time window by applying the time window, and vectorizing the divided health data and personal health data.

In an embodiment, the learning model may establish the learning model for reducing a dimension of the preprocessed health data, wherein a technique for reducing a health data dimension, such as deep network learning or principal component analysis (PCA), may be applied to the learning model. The technique for the learning model is not particularly limited in embodiments of the inventive concept.

In an embodiment, the clustering unit may store the health data for a corresponding cluster by grouping by each of the extracted features for the learning model, wherein the grouping may be performed through lattice-based grouping or cube-type grouping.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a conceptual diagram illustrating a method and device for searching for a similar case for multi-dimensional health data according to an embodiment of the inventive concept;

FIG. 2 is a block diagram illustrating a configuration of a similar case search device according to an embodiment of the inventive concept;

FIG. 3 is a workflow illustrating a procedure for searching for a similar case to personal health data of a user by a similar case search device according to an embodiment of the inventive concept;

FIG. 4 is a flowchart illustrating a procedure for establishing a similar case search model in a similar case search device according to an embodiment of the inventive concept;

FIG. 5 is a flowchart illustrating a procedure for searching for a similar case to personal health data of a user based on personal health data of a user according to an embodiment of the inventive concept;

FIG. 6A and FIG. 6B are a diagram exemplarily illustrating health data normalized to search for a similar case on the basis of personal health data of a user according to an embodiment of the inventive concept;

FIG. 7A and FIG. 7B are a diagram exemplarily illustrating that health data normalized to search for a similar case based on personal health data of a user is divided by a length of a time window by applying the time window according to an embodiment of the inventive concept;

FIG. 8 is a diagram exemplarily illustrating a process of performing two-dimensional-lattice-based grouping on data values of health data according to an embodiment of the inventive concept; and

FIG. 9 is a diagram exemplarily illustrating that health data is grouped (clustered) and stored according to an embodiment of the inventive concept.

### DETAILED DESCRIPTION

Hereinafter, embodiments of the inventive concept will be described in detail with reference to the accompanying drawings. Like reference numerals refer to like elements throughout.

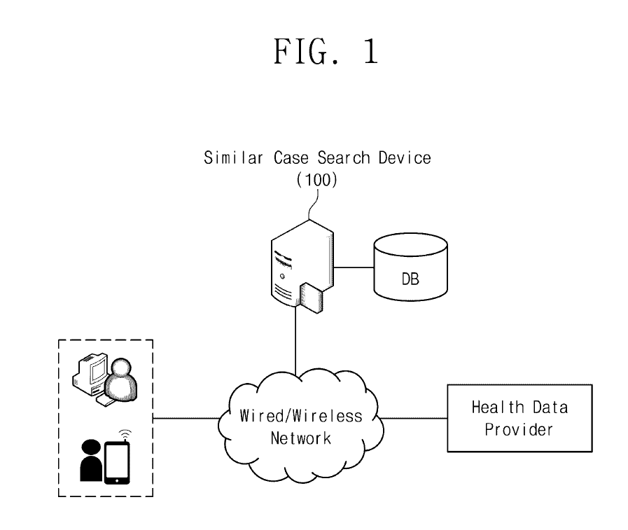

FIG. 1 is a conceptual diagram illustrating a method and device for searching for a similar case from multi-dimensional health data according to an embodiment of the inventive concept.

Recently, as people pay more attention to their health, a health-big-data-based service has been started to collect personal health data of a user, search for similar cases of persons having diseases similar or identical to a disease of the user, and provide reference materials for promoting health on the basis of the similar cases.

That is, similar cases of persons having health condition similar to that of the user are found, so that future health condition of the user may be predicted on the basis of progress of health condition changes of the persons, and a personal health promotion method may be found on the basis of symptoms, living habits, eating habits, prescriptions, etc. from the similar cases. Therefore, it is very important to find the similar cases to the health condition of the user.

Furthermore, the health data is a record of results of personal periodic medical examinations or is a record of progress of a treatment, and is thus considered to be time-series data. Moreover, since the health data includes various numerical health values, the health data is multivariate data.

To calculate similarity between the health data having the characteristics of multivariate time-series data, each of various numerical health values based on a time series should be compared. Therefore, calculation complexity is very high, and time complexity is also high since the data is large-size health big data.

As described above, a result of the similar case search based on the personal health data of the user is reference information that may be used as a reference material for predicting health condition of the user or promoting health of the user. Therefore, it is required to perform the similar case search in near real time in order to smoothly provide a healthcare service.

Therefore, embodiments of the inventive concept provide a device and method for quickly searching for similar cases to the personal health data of the user. According to the device and method, calculation complexity of a similar case search is remarkably reduced by reducing a dimension of large-size health data provided from domestic or foreign large medical institutions or government by extracting a feature from the large-size health data, and the health data is grouped according to the extracted feature to perform a similarity calculation only for heath data within a group selected through group screening instead of performing the similarity calculation for all health data, so that the similar cases to the personal health data of the user may be quickly retrieved from the large-size health data.

As illustrated in FIG. 1, a similar case search device 100 preferentially establishes a search model to search health data for a similar case on the basis of personal health data of a user. Here, health data used for establishing the search model may represent health data including public health data and personal health data.

In order to establish the search model, the similar case search device 100 periodically collects the public health data and the personal health data from a health data provider which provides the health data, and performs preprocessing so as to render features of numerical health values (e.g., blood glucose, blood pressure, cholesterol level, etc.) of the health data comparable with the personal health data of the user.

Furthermore, during the preprocessing, in the case where the health data does not follow a normal distribution, the health data is made to follow a normal distribution so that the numerical health values of the health data are rendered comparable with the personal health data of the user, and z-score for the health data in a normal distribution is rescaled into a value of from 0 to 1.

The rescaling represents that the numerical values of the health data are converted into a probability value of from 0 to 1 in order to generate a learning model on the basis of the health data in a normal distribution.

During the preprocessing, in the case where there exists a blank for each numerical value of the health data, a specific value may be inserted thereto to be substituted, wherein the specific value may be replaced with 0 or a median value.

The median value represents a median value of numerical values of earlier and later times than a numerical value with a blank due to characteristics of time-series health data.

Furthermore, during the preprocessing, the normalized health data is divided by a length of a time window so as to correspond to the personal health data which is time-series data having various lengths, and the divided health data is vectorized.

For example, when there exists health data between the year 2002 and the year 2006 for one person (or more persons), the health data is divided into data of 2002-2004, data of 2003-2005, and data of 2004-2006 by applying a time window having a length of 3.

The length of the time window is not fixed, and may be variously given according to the health data and the personal health data of the user. According to the length of the time window applied to the health data, the health data may be divided into a plurality of health data.

Furthermore, during the preprocessing, each of the plurality of divided health data is vectorized. This vectorization represents that a characteristic value is made one vector according to a time series of the divided health data.

That is, the divided health data is multivariate data, i.e., has a plurality of characteristic values according to a plurality of times. Therefore, since each of the plurality of characteristic values should be compared according to each time in order to search the health data on the basis of the personal health data of the user, it takes a long time to perform the search.

Therefore, the vectorization is performed such that, for example, if blood glucose, blood pressure, and cholesterol level are given to one person “A” according to a plurality of times, blood glucose and blood pressure of the years 2002 and 2003 are made vectors of 2002_blood glucose, 2003_blood glucose, 2002_blood pressure, and 2003_blood pressure.

Furthermore, query data, which is input by the user to search for a similar case from the health data on the basis of the personal health data of the user, is converted through the preprocessing.

The similar case search device 100 establishes a learning model for reducing the dimension of the health data, and when all the health data is input through the learning model, the similar case search device 100 converts corresponding health data by reducing the dimension of the corresponding health data by extracting features from the health data.

For example, features are extracted from the blood pressure and blood glucose data having the form of 2002_blood glucose, 2003_blood glucose, 2002_blood pressure, and 2003_blood pressure of the person “A”, and are converted in the form of (feature 1, feature 2) to thereby reduce the dimension of the corresponding health data.

The similar case search device 100 divides the health data to establish the learning model for each vectorized health data. That is, the similar case search device 100 generates and establishes at least one learning model according to a length of a time window applied to the health data.

When the conversion of the health data is completed, the similar case search device 100 performs grouping (in the case where the conversion of the health data is two dimensional) based on a lattice to divide numerical values (features) of the dimension-reduced health data into cells so that a similar case group may be quickly retrieved through a cell search, i.e., a range search, at the time of searching for a similar case on the basis of the personal health data of the user. That is, a similarity calculation may be performed only for health data within retrieved similar groups instead of performing the similarity calculation for all the health data in order to search for a similar case for the personal health data of the user, and thus a time required for searching for the similar case may be remarkably reduced.

The original health data is mapped to each feature so as to be stored in a database.

The above-mentioned series of processes is performed to establish a model for searching for a similar case, and the user may search for a similar case similar to health condition of the user on the basis of the established model using the personal health data of the user.

That is, the user may search for the similar case through the similar case search device 100 using the personal health data of the user as query data, and the similar case search device 100 performs the preprocessing on the query data in the same manner as performed on the health data, and applies the preprocessed query data to the generated learning model to extract the query data, a data format of which has been converted in the same manner as the health data.

That is, once the user inputs the personal health data of the user in order to search for a similar case to the health condition of the user, the similar case search device 100 performs the preprocessing on the personal health data, and extracts the query data by converting data of corresponding personal health data by applying a learning model suitable for a length of the corresponding personal health data among the plurality of established learning models.

Furthermore, the similar case search device 100 selects a corresponding group from groups grouped by feature of the health data extracted from the health data and the established learning model by using the converted query data.

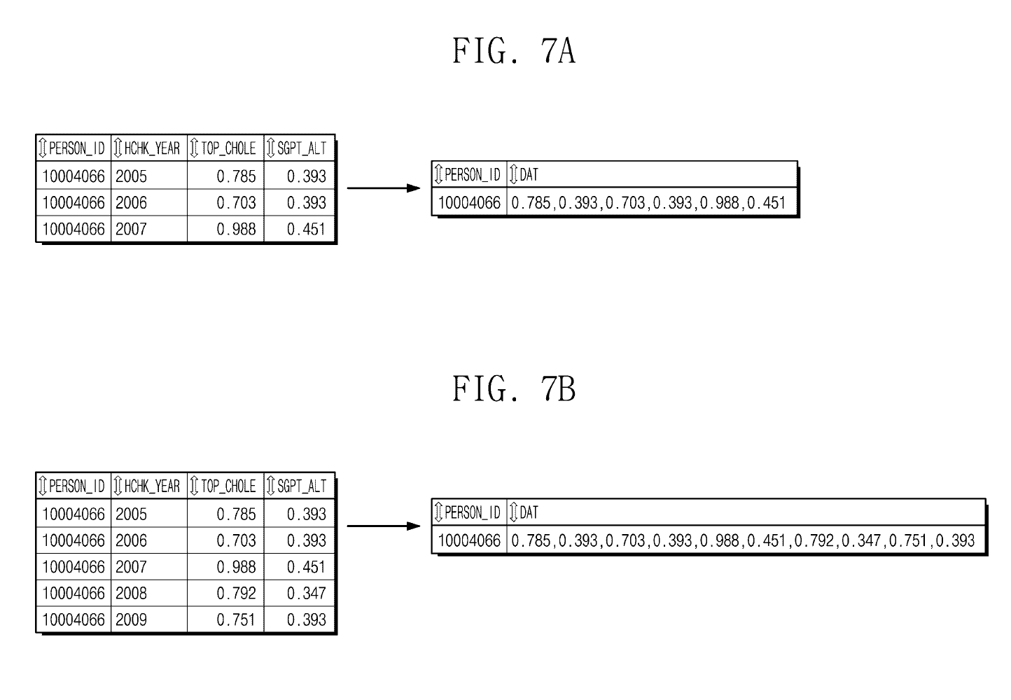

For example, provided that the health data is converted into a two dimension, lattice-based grouping is performed thereon to store x, y values of each cell (lattice) in advance, and a cell A is 0.1<x<0.2 and 0.2<y<0.3 when new data is converted and input, if data of <0.15, 0.15> is input, it may be detected that the personal health data of the user corresponds to the cell A through a simple range search, and thus a similar case group may be discovered quickly. This operation is described in more detail below with reference to FIG. 8.

The similar case search device 100 predicts similarity by calculating 1:1 similarity between the personal health data of the user and the health data within the selected similar case group, and selects one or more health data having a high similarity as a result of the similarity prediction to provide, to the user, the selected health data together with a numerical value thereof.

The similar case search device 100 performs the similarity calculation using a distance calculation method such as Manhattan distance or Euclidean distance, and the personal health data of the user and the original health data, which are not converted into k dimension, are used as the personal health data of the user and each health data used for the 1:1 similarity calculation, so that accuracy may be secured.

The similar case search model may be used not only in searching for a similar case based on health data but also in various fields of searching for a similar case based on big data having characteristics of multivariate time-series data such as the health data.

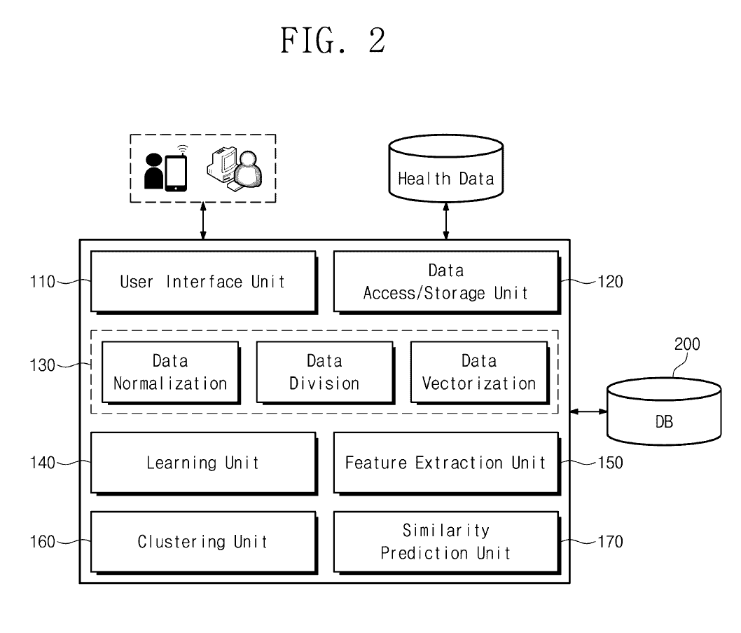

FIG. 2 is a block diagram illustrating a configuration of a similar case search device according to an embodiment of the inventive concept.

As illustrated in FIG. 2, the similar case search device 100 includes a user interface unit 110 which provides a user interface for allowing a user to search for a similar case on the basis of the personal health data of the user, a data access/storage unit 120 which accesses health data from a health data provider which provides the health data to update a database for storing the health data, a preprocessing unit 130 which performs preprocessing on the health data and the personal health data of the user, a learning unit 140 which generates a corresponding learning model through learning on the health data, a feature extraction unit 150 which extracts features of the health data by applying the generated learning model to the health data, a clustering unit 160 which establishes clusters of similar health data by grouping the health data by each feature, and a similarity prediction unit 170 which predicts similarity between the health data and the personal health data of the user.

The user interface unit 110 supports the user so that the user may search for a similar case to the health condition of the user by allowing the user to input query data through the user interface 110.

The query data represents the personal health data of the user having multivariate time-series characteristics.

Here, it is a matter of course that the user is not required to input all feature values of the personal health data of the user and may input a part of the personal health data in order to search for a similar case desired by the user.

The data access/storage unit 120 is connected to the Internet to periodically access the health data from the health data provider, cluster the accessed health data through the similar case search model, and update a database 200. This operation allows the user to search for a wider range of similar cases.

The user interface 110 or the data access/storage unit 120, which receives the personal health data of the user and the health data, is not necessarily provided to the similar case search device 100, and in this case, the personal health data of the user and the health data may be received through a system for providing a health promotion service in association with the similar case search device 100.

The preprocessing 130 performs preprocessing on query data input by the user to search for a similar case to the health condition of the user, the health data, or a combination thereof.

During the preprocessing, the query data and the health data are normalized, the normalized query data and health data are divided according to a length of at least one time window, and the divided one or more query data and one or more health data are vectorized.

Regarding the normalization, in the case where the query data and the health data do not follow a normal distribution, the query data and the health data are made to follow a normal distribution through log transformation or square root transformation, and each numerical value of the query data and the health data which follow a normal distribution is converted into a form of a probability value (from 0 to 1).

Moreover, during the preprocessing, in the case where a numerical value of the query data or the health data is blank or a correct numerical value cannot be recognized, the corresponding numerical value (representing inclusion of a blank) is replaced with 0 or a median value.

The above-mentioned division and vectorization have been described above, and are thus not described in detail here.

A preprocessing unit (e.g., a first preprocessing unit) for processing the query data and a preprocessing unit (e.g., a second preprocessing unit) for processing the health data may be individually configured in the preprocessing unit 130 so as to perform the preprocessing.

The learning unit 140 establishes a learning model for reducing dimensions of the health data and the query data, and the learning model serves to reduce the dimensions of the query data and the health data. The learning model is established as at least one learning model according to the number of time windows applied to divide the health data or the query data of the user for each feature according to a time.

That is, when the preprocessed query data and health data are N dimensional (the number of the features or the number of the numerical values), the dimensions of the query data and the health data are reduced to k dimension (N>k) through the learning model.

The feature extraction unit 150 serves to reduce the dimension of the health data by extracting a feature required for searching for a similar case by applying the health data to the learning model. That is, the feature extraction unit 150 reduces the dimension of the health data in association with the learning model.

The clustering unit 160 groups a plurality of health data by each extracted feature. A group of grouped health data constitutes one cluster.

Furthermore, the clustering unit 160 stores the health data for a corresponding cluster by grouping the health data by each feature extracted from the health data by applying the learning model, wherein the grouping is performed through lattice-based grouping or cube-type grouping.

The lattice-based grouping represents that the health data is converted into two-dimensional data through the learning model so as to be grouped, and the cube-type grouping represents that the health data is converted into three-dimensional data so as to be grouped.

The dimension is k dimension, and is not limited to two or three dimension.

The similarity prediction unit 170 applies the query data to the generated learning model, selects a corresponding cluster from the clusters obtained by performing the grouping using the query data converted by the learning model, and predicts similarity between the personal health data of the user and the health data corresponding to the selected cluster.

The similar case search device 100 selects one or more health data having a high similarity with the personal health data as a result of similarity prediction by the similarity prediction unit 170, and provides, to the user, the selected health data and a similarity prediction value for each of the selected health data.

The original health data and personal health data of the user (i.e., not k-dimensional data) input to the similar case search device 100 are used to predict the similarity, and this similarity prediction is performed using the Euclidean distance. However, various distance calculation methods other than the Euclidean distance, such as the Manhattan distance and Hamming distance, may be used, and embodiments of the inventive concept is not limited thereto.

The similar case search device 100 may be implemented in a computer system, e.g., as a computer readable medium. The computer system may include one or more of a processor, an input device, an output device, and a storage, each of which communicates through a bus. The computer system may also include a network interface that is coupled to a network.

The processor may include a central processing unit (CPU) and an application processor. The processor executes processing instructions stored in the storage. For example, the preprocessing unit 130, the learning unit 140, the feature extraction unit 150, the clustering 160, and the similarity prediction unit 170 may be implemented in the processor. The storage may include various forms of volatile or non-volatile storage media. The storage may store the health data or the query data.

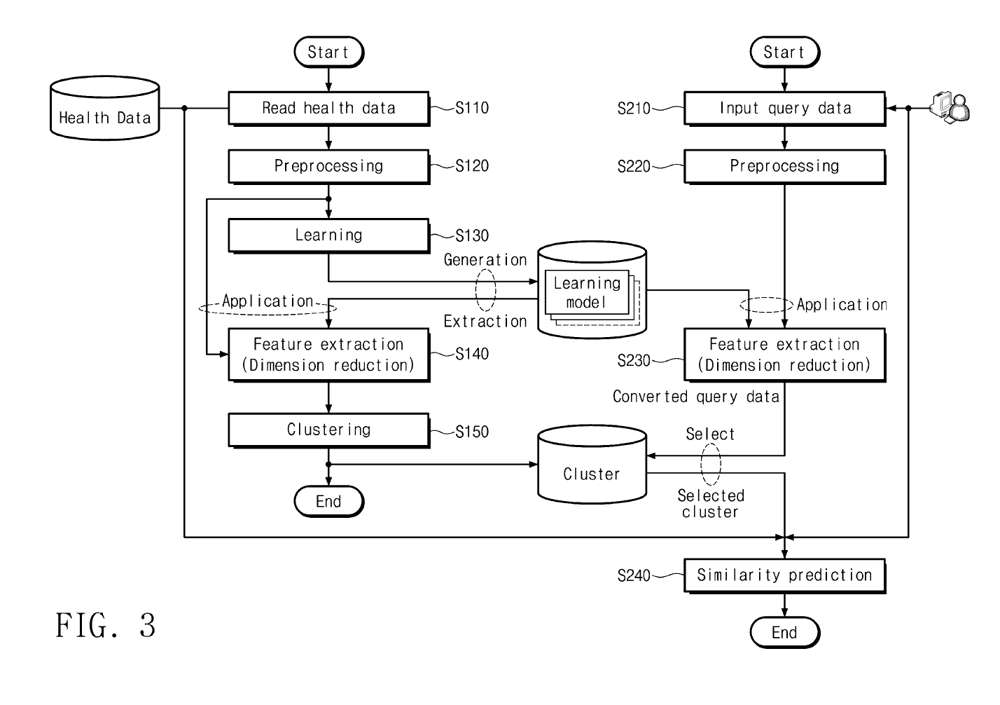

FIG. 3 is a workflow illustrating a procedure for searching for a similar case by a similar case search device according to an embodiment of the inventive concept.

As illustrated in FIG. 3, in the workflow in which the user searches for a similar case to the health condition of the user using query data based on the personal health data, the user inputs the query data through a terminal provided to the user (S210).

The query data may be the entirety of the personal health data including personal time-series medical examination data of the user, or may be a part of the personal health data.

When inputting the query data, the user inputs the query data through a user interface provided by the similar case search device 100 or a user interface provided by a medical examination system interworking with the similar case search device 100.

Next, once the query data of the user is input, the similar case search device 100 performs the preprocessing so that each numerical health value contained in the query data of the user is rendered comparable and applicable to the learning model.

The health data input to the similar case search device 100 represents reference data derived as a result of the similar case search, and the preprocessing is also performed on the input health data (S110-S120).

The health data is periodically collected through the similar case search device 100 or a health promotion service system interworking with the similar case search device 100.

Furthermore, the health data includes health big data provided from domestic or foreign large hospitals, National Health Insurance Service, or Health Insurance Review & Assessment Service.

The similar case search device 100 generates at least one learning model through learning on the health data in order to use the health data as a target of a similar case search (S130), stores the generated learning model in the database 200, and reduces the dimension of the health data to a k dimension by extracting features of the health data by applying the preprocessed health data to the generated learning model (S140).

The similar case search device 100 applies the query data of the user which has been preprocessed to one of the stored learning models so as to extract features, and then outputs converted query data obtained by reducing the dimension of corresponding query data to a k dimension (S230).

The similar case search device 100 performs grouping by each of the features extracted from the health data, and stores the health data for grouped clusters (S150).

The similar case search device 100 selects a cluster corresponding to the converted query data from the clusters obtained through grouping by each feature using the converted query data, predicts similarity between one or more health data corresponding to the selected cluster and the personal health data of the user through 1:1 mapping, and selects a plurality of health data having high similarity as a result of the prediction to provide, to the user, the selected health data together with predicted similarity (S240).

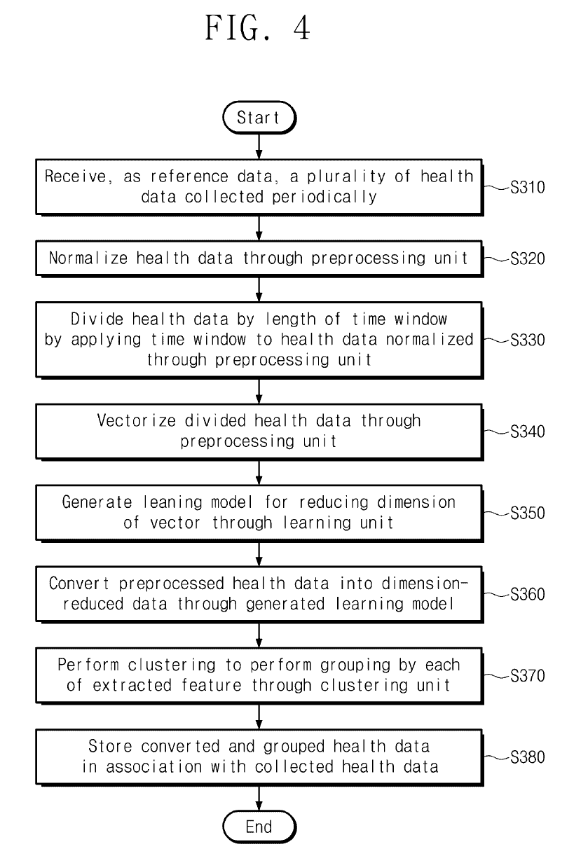

FIG. 4 is a flowchart illustrating a procedure for establishing a similar case search model in a similar case search device according to an embodiment of the inventive concept.

As illustrated in FIG. 4, in the procedure for establishing a similar case search model, a plurality of health data periodically collected are normalized through the preprocessing unit 130 (S320).

Periodically collecting the health data is performed by the similar case search device 100 or the health promotion service system interworking with the similar case search device 100. The plurality of health data collected periodically are received as reference data (S310). Next, preprocessing is performed through the preprocessing unit 130 so that the health data is normalized (S320), the normalized health data is divided by a length of a corresponding time window by applying the time window having various lengths, and the divided health data is vectorized (S330, S340).

Next, a corresponding learning model is generated through learning on the preprocessed health data (S350). The learning model serves to reduce the dimension of the health data so as to remarkably reduce the complexity of a calculation for a similar case search performed by the similar case search device 100.

Next, the dimension of the preprocessed health data is reduced by extracting features therefrom through the feature extraction unit 150 and the generated learning model (S360).

This reduction of dimension may remarkably reduce a time complexity of a similarity calculation for a similar case search performed by the similar case search device 100.

Next, clustering is performed through the clustering unit 160 to perform grouping by each feature (S370).

This clustering represents that the health data are grouped by feature, and one group of a plurality of health data obtained through this grouping constitutes one cluster.

Next, the health data for a corresponding cluster is stored (S380).

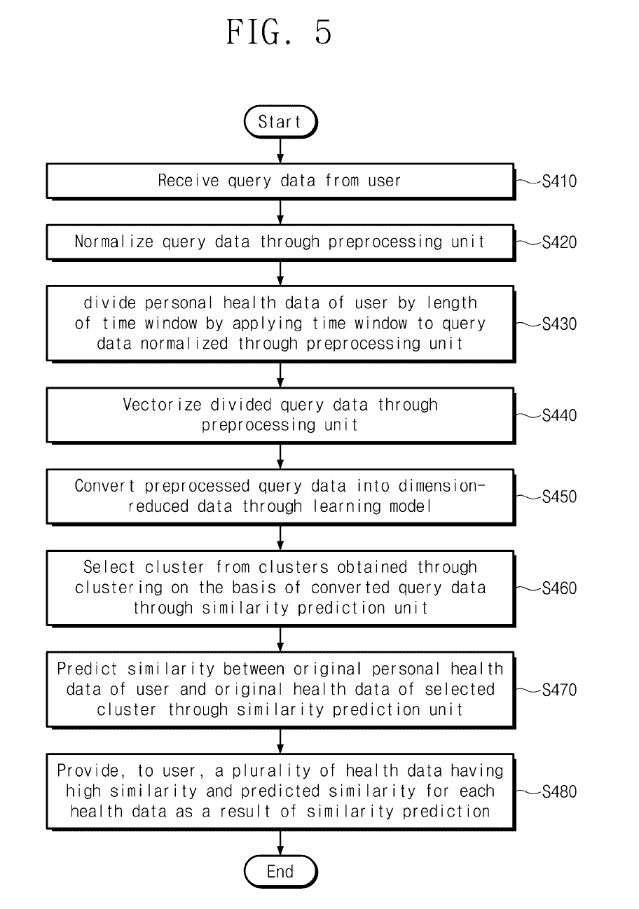

FIG. 5 is a flowchart illustrating a procedure for searching for a similar case based on personal health data of a user according to an embodiment of the inventive concept.

As illustrated in FIG. 5, in the procedure for searching for a similar case based on personal health data of a user, a query data for searching the health data for a similar case to health condition of the user on the basis of the personal health data of the user is received from the user (S410).

The personal health data of the user is multivariate time-series data provided from a plurality of personal health data providers which provide medical services, such as hospitals or oriental medical clinics where the user has received medical treatment or has taken a medical examination.

Next, preprocessing is performed through the preprocessing unit 130 so that the query data is normalized, the normalized query data is divided by a length of a corresponding time window by applying the time window having various lengths, and the divided query data is vectorized (S420, S430, and S440). Here, when the amount of the query data is small, the application of the time window may be skipped.

Next, the preprocessed query data is converted into dimension-reduced data through a learning model generated by the learning unit 140 (S450).

Next, a corresponding cluster is selected from clusters obtained by performing grouping according to features of the health data on the basis of the converted query data through the similarity prediction unit 170 (S460).

Next, similarity between the personal health data of the user and the health data corresponding to the selected cluster is predicted (S470).

The health data and the personal health data of the user used for predicting the similarity are not the k-dimensional health data and personal health data used for searching for the similar case but the original health data and personal health data initially input to the similar case search device 100.

Next, as a result of similarity prediction, the health data having highest similarity is provided to the user (S480).

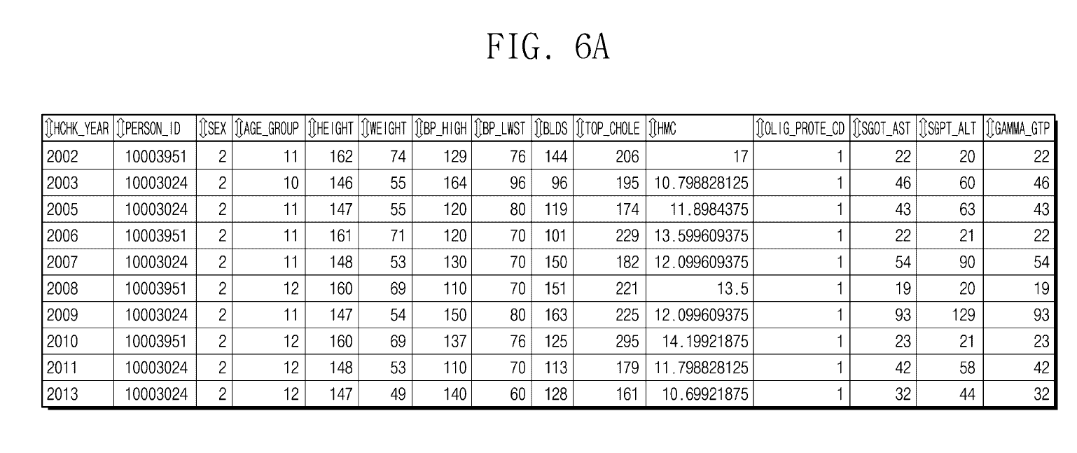

FIG. 6 is a diagram exemplarily illustrating health data normalized to search for a similar case on the basis of data of a user according to an embodiment of the inventive concept.

FIG. 6A exemplarily illustrates health data provided from a health data provider.

As illustrated in FIG. 6A, health data has a basic format in which numerical health values and user's simple information are sequentially arranged by time according to the user (PERSON ID in FIG. 6A) of the health data.

As described above, the health data is multivariate time-series data in which numerical health values of the user are arranged for each date on which the user received medical treatment or took a medical examination in a hospital or an oriental medical clinic.

To calculate similarity between the health data and personal health data of a specific person, each numerical health value should be compared with the personal health data for each date. Therefore, the complexity of the calculation is very high, and a time taken for calculating the similarity is long.

FIG. 6B exemplarily illustrates a normalized form of health data provided from a health data provider.

As illustrated in FIG. 6B, the health data is normalized through the similar case search device 100. Since the features of the health data are different from each other with respect to range and scale, the normalization is performed to make the features have the same range so that the features are comparable with each other.

As described above, the similar case search device 100 may perform log transformation or square root transformation on the health data to generate the learning model. The health data or log-transformed or square-root-transformed health data is transformed into z-core (numerical health value, user's height or weight, etc.), and the transformed value is rescaled to a value of from 0 to 1.

In the case where a value of the health data is blank, the similar case search device 100 may replace the value of the health data with a specific value (0 or a median value).

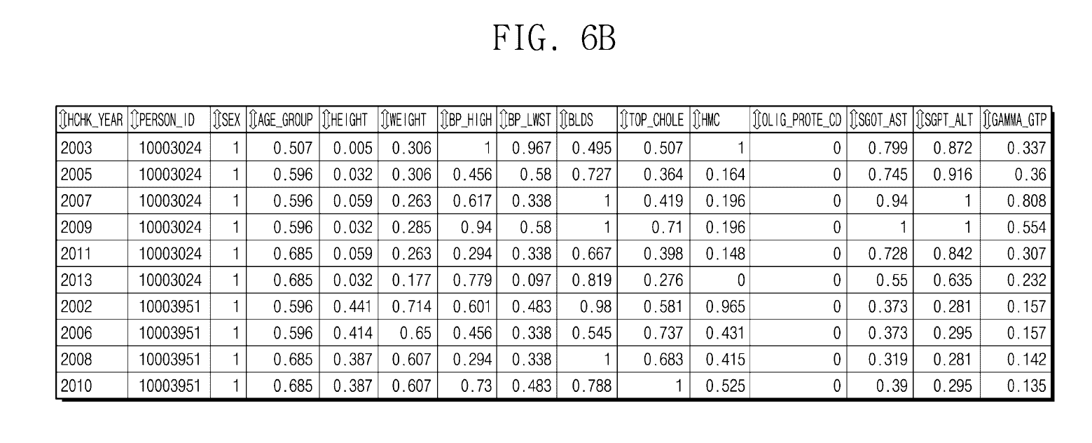

The normalization process for the health data described above with reference to FIG. 6 includes a process of dividing the health data by a length of a time window by applying the time window described below with reference to FIG. 7, and the normalization process may also be performed on the query data of the user as described above.

FIG. 7 is a diagram exemplarily illustrating that health data normalized to search for a similar case based on personal health data of a user is divided by a length of a time window by applying the time window according to an embodiment of the inventive concept.

As illustrated in FIG. 7, health big data may be encoded by applying time windows with various lengths so as to correspond to user's time-series health data with various lengths input to the similar case search device 100.

FIG. 7A illustrates an example of application of 3-length time window, and FIG. 7B illustrates an example of application of 5-length time window.

As described above, time windows with various lengths may be applied according to the personal health data of the user.

The similar case search device 100 may apply time windows with one or more different lengths to the health data to divide the health data by each length of the time windows, and may establish at least one learning model according to the lengths of the time windows applied.

In addition, since the similar case search device 100 reduces the dimension of the health data on the basis of the time-window-applied health data and performs lattice-based grouping, the time taken for calculating the similarity may be remarkably reduced so that the similar case search may be performed in real time.

FIG. 8 is a diagram exemplarily illustrating a process of performing two-dimensional-lattice-based grouping on data values of health data according to an embodiment of the inventive concept.

As illustrated in FIG. 8, the dimension (e.g., N dimension) of the original health data initially input to the similar case search device 100 is reduced (e.g., two dimension, N>2) through the preprocessing, the learning model, and the feature extraction unit 150.

By performing the lattice-based grouping through the clustering unit 160, the public health data mapped to two dimension is divided into cells for each interval of values.

The cell for each interval represents one cluster (group of health data having high similarity), and this cluster includes one or more health data.

The cluster configured with the health data represents a group of health data having similar values (i.e., the features or numerical health values), and the health data included in the cluster have similar features.

The health data may be converted into two-dimensional data through the learning model or the feature extraction unit 150, and may be displayed in the form of a dot on a two-dimensional graph by mapping the health data onto the two-dimensional graph using each element (the above-mentioned features) of the two-dimensional data as x-axis or y-axis value.

The lattice represents a rectangular lattice having an x-value range and a y-value range on the two-dimensional graph of FIG. 8, and represents one group. X and y values of each cell are stored in advance, so that when new health data is converted and input, a similar case group may be quickly retrieved and clustered through a simple range search.

For example, provided that a cell A is 0.1<x<0.2 and 0.2<y<0.3, when health data having a two-dimensional value of <0.15, 0.15> is input, it may be detected that the input health data corresponds to the cell A through a simple range search.

Meanwhile, although it has been exemplarily described that the health data is converted into two-dimensional data through the learning model and the feature extraction unit 150, the health data may be converted into three-dimensional data, and in this case, the data may be grouped in the form of a cube through the clustering unit 160 so as to be mapped to a three-dimensional graph. That is, the health data may be grouped in various forms according to a dimension to which the health data is converted through the learning model and the feature extraction unit 150, and may be mapped to various types of k-dimensional graphs.

The similarity search device 100 selects a clustered similar case group through the range search in order to search for a similar case to the query data of the user on the basis of the query data which has been input and of which the dimension has been converted to be reduced to a two dimension through the learning model.

In the case where the input and converted query data of the user is present at a boundary of a specific similar case group (in the case where the personal health data of the user has a value of <0.199, 0.201> in the above example), the similar case search device 100 may select not only a similar case mapped to the corresponding cell but also a plurality of clusters mapped to cells adjacent to the corresponding cell.

That is, since it is highly possible that the query data of the user is similar to not only the similar case grouped in the corresponding cell but also similar cases grouped in other cells adjacent to the corresponding cell, selecting only the group of the similar case of the corresponding cell may cause false-positive.

Therefore, the similar case search device 100 divides the group into groups, so that when the query data of the user is mapped to a specific group, the similar case search device 100 selects not only the corresponding group but also other groups adjacent thereto (the rectangles of the red dotted line of FIG. 8, nine rectangles in total in the case of two dimension) as similar groups.

The above-mentioned grouping is performed for screening, and a correct similarity calculation is performed only for similar cases within a group selected through the similarity prediction unit 170, so that a similar case may be retrieved quickly.

The similarity prediction unit 170 performs 1:1 similarity prediction between the health data within the selected cluster and the personal health data of the user.

Since the similarity prediction unit 170 performs the similarity prediction using the original query data of the user and the original health data instead of the health data converted into a two dimension, the accuracy of the similar case search may be secured.

The similarity prediction unit 170 calculates similarity using one of various distance calculation methods such as the Euclidean distance, the Manhattan distance, and the Hamming distance.

The similar case search device 100 selects one or more health data having high similarity according to a result of similarity prediction by the similarity prediction unit 170, and provides, to the user, the selected health data together with numerical values of each similarity.

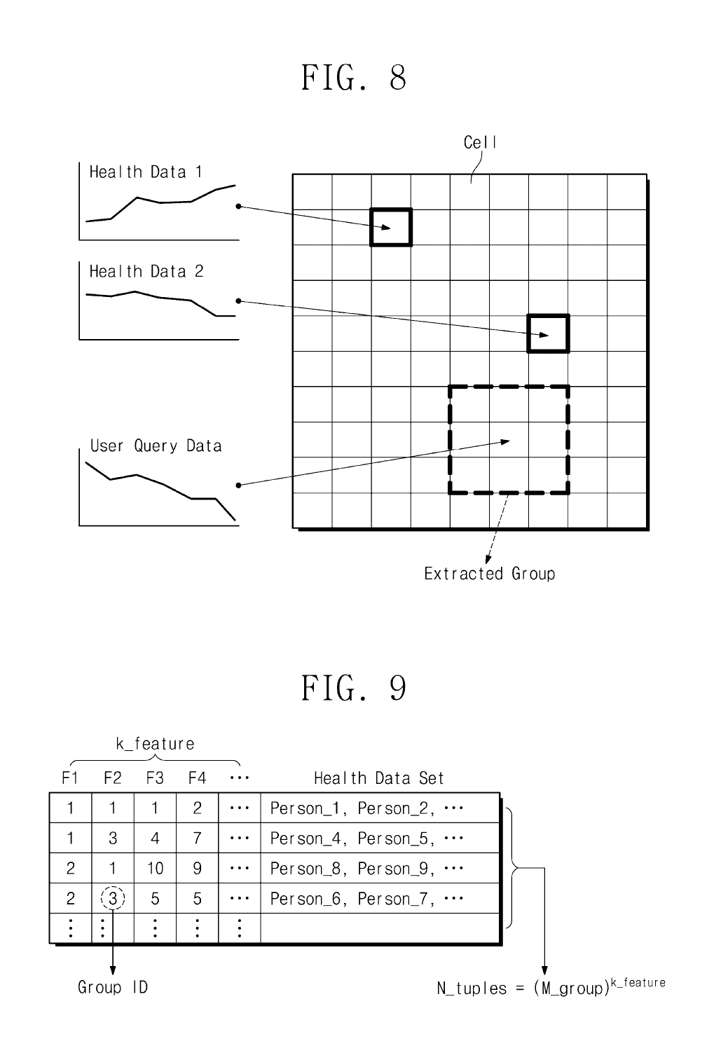

FIG. 9 is a diagram exemplarily illustrating that health data are grouped (clustered) and stored according to an embodiment of the inventive concept.

According to an embodiment of the inventive concept, a plurality of n-dimensional health data are collected by the similar case search device 100, are converted to a k dimension through a series of processes, and are stored in the database 200 after being grouped.

The plurality of grouped health data are used as reference data to be provided as a result of a similar case search based on the personal health data.

As illustrated in FIG. 9, the health data stored in the database 200 after being grouped in a k dimension through the similar case search device 100 include a field indicating variates for k number of features and a field indicating a health data set for a combination of the variates for the features.

Target fields (search conditions) used for a similar case search are variates for the features, and a group ID of a corresponding variate is stored as a value of each field.

The group ID represents a range (variate) of numerical values for each feature. For example, in FIG. 9, F1 represents a feature for blood glucose, and if a numerical value of blood glucose ranges from 1 to 100, a group ID, 1, may be allocated to a range of 1-10, and group IDs may be sequentially allocated in units of 10. The group ID of each field for a variate may also be arbitrarily allocated by the similar case search device 100.

Furthermore, the field indicating a health data set stores a set of health data included in a corresponding group for a combination of various variates (combination according to a group).

For example, in FIG. 9, for the field indicating a health data set, health data of Person_1 and Person_2 have groups ID (1, 1, 1, and 2) indicating variates of features (F1, F2, F3, and F4).

Provided that the data structure illustrated in FIG. 9 is a database table, the number of tuples (the number of rows) is a factor which greatly affects a time taken for searching for a similar case.

The number of tuples may be expressed as Equation (1).

N_tuples=(M_group)^{K}^{_}^{feature} (1)
where N, M, and K are integers not less than 1.

In the case where only clustering is performed on n-dimensional health data without reducing the dimension of the health data, the number of tuples to be searched to search for the similar case is large since the value of K_feature is still large, and the time taken for the search is long, as expressed in Equation (1). Therefore, it would be obvious that the time taken for the search becomes longer in the case where even the clustering is not performed.

However, according to embodiments of the inventive concept, the clustering is performed after reducing the dimension through the preprocessing, the learning model, and the feature extraction process, so that the time take for searching for the similar case may be remarkably reduced.

For example, in the case of health data of five years including 20 features, the health data is 100 (=20×5)-dimensional data, and in the case where variates for the features are grouped into five groups, 5100 tuples are required to enable group screening. However, if the 100-dimensional health data is converted into 25-dimensional data by reducing the 20 features to five features, the group screening may be performed only with 525 tuples, and the time taken for searching for the similar case may be reduced by as much as the reduced number of tuples.

One more reason to reduce the n-dimensional health data to k-dimensional data is that constraints increase as the dimension increases, and data should belong to a corresponding group in all of n-dimension (100 dimension in the case of the above example) so as to be selected without failing in the group screening.

In the above example, in the case where values of 99 dimensions are similar to each other but a value of one dimension is significantly different, this value may be matched to a wrong group or may not be selected in the group screening. However, the number of constraints to be satisfied is reduced as the dimension decreases, so that the accuracy of clustering may be improved.

Therefore, according to embodiments of the inventive concept, n-dimensional health data is decreased in dimension to k-dimensional health data to group the health data in a k dimension, so that the number of tuples is reduced to thereby remarkably improve a similar case search speed. Furthermore, since only feature parts are extracted by combining the health data through the dimension reduction, the number of constraints on a similar case search is reduced so that the similar case search may be performed with high accuracy.

As described above, according to the similar case search method and device for multi-dimensional health data, a search model for searching for health data similar to health condition of the user is established on the basis of the personal health data of the user, so that the complexity of a calculation of similarity between the personal health data and the health data is reduced, thereby remarkably reducing the time taken for searching for the similar case.

According to embodiments of the inventive concept, the dimension of health data having multivariate time-series characteristics is reduced by applying a feature extraction technique so as to reduce the complexity of a calculation for searching for a similar case from the health data on the basis of personal health data of a user, so that a similar case similar to the personal health data of the user may be retrieved quickly in near real time.

Furthermore, according to embodiments of the inventive concept, the similarity calculation is not performed for all health data but is performed only for health data within a group selected through group screening by applying a grouping technique suitable for the personal health data of the user, so that the time taken for searching for the similar case to the personal health data of the user may be remarkably reduced.

An embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method for searching for a similar case from multi-dimensional health data, the method comprising:
preprocessing health data or personal health data of a user; and
generating a corresponding learning model through learning on the health data.

2. The method of claim 1, further comprising:
extracting features of the health data from the health data and the learning model; and
performing clustering to perform grouping by each of the extracted features.

3. The method of claim 1, further comprising extracting converted query data by applying personal health data of a user to the generated learning model.

4. The method of claim 3, further comprising:
selecting a corresponding cluster from clusters obtained by performing grouping by each of the features of the health data extracted from the health data and the generated learning model using the converted query data; and
predicting similarity between the personal health data of the user and the health data corresponding to the selected cluster.

5. The method of claim 1, wherein the preprocessing comprises:
normalizing the health data, personal health data of a user, or a combination thereof;
dividing the normalized health data and personal health data by a length of a time window by applying the time window; and
vectorizing the divided health data and personal health data.

6. The method of claim 5, wherein the normalizing comprises making the health data and the personal health data of the user follow a normal distribution through log transformation or square root transformation in a case where the health data and the personal health data of the user do not follow the normal distribution and rescaling z-score for the health data and the personal health data of the user which follow the normal distribution to a value of from 0 to 1.

7. The method of claim 1, wherein during the generating the corresponding learning model, the learning model for reducing a dimension of the preprocessed health data is established, wherein a technique for reducing a health data dimension, such as deep network learning or principal component analysis (PCA), is applied to the learning model.

8. The method of claim 2, wherein the performing the clustering comprises storing the health data for a corresponding cluster by grouping by each of the extracted features for the learning model, wherein the grouping is performed through lattice-based grouping or cube-type grouping.

9. A device for searching for a similar case from multi-dimensional health data, the device comprising:
a preprocessing unit configured to preprocess health data or personal health data of a user; and
a learning model configured to generate a corresponding learning model through learning on the health data.

10. The device of claim 9, further comprising:
a feature extraction unit configured to extract features of the health data from the health data and the learning model; and
a clustering unit configured to perform grouping by each of the extracted features.

11. The device of claim 9, further comprising:
a similarity prediction unit configured to select a corresponding cluster from clusters obtained by performing grouping by each of the features of the health data extracted from the health data and the generated learning model using query data converted by applying the personal health data of the user to the generated learning model, and predict similarity between the personal health data of the user and the health data corresponding to the selected cluster.

12. The device of claim 9, wherein the preprocessing unit performs a process of normalizing the health data, the personal health data of the user, or a combination thereof, dividing the normalized health data and personal health data by a length of a time window by applying the time window, and vectorizing the divided health data and personal health data.

13. The device of claim 12, wherein the normalizing comprises making the health data and the personal health data of the user follow a normal distribution through log transformation or square root transformation in a case where the health data and the personal health data of the user do not follow the normal distribution and rescaling z-score for the health data and the personal health data of the user which follow the normal distribution to a value of from 0 to 1.

14. The device of claim 9, wherein the learning model establishes the learning model for reducing a dimension of the preprocessed health data, wherein a technique for reducing a health data dimension, such as deep network learning or principal component analysis (PCA), is applied to the learning model.

15. The device of claim 10, wherein the clustering unit stores the health data for a corresponding cluster by grouping by each of the extracted features for the learning model, wherein the grouping is performed through lattice-based grouping or cube-type grouping.
